(19) United States
(12) Patent Application Publication
(10) Pub. No.: US 2026/0035979 A1
(43) Pub. Date: Feb. 5, 2026

(54) ASSEMBLY CONSISTING OF A DRIVE DEVICE, A COMPONENT FOR CLOSING AN OPENING, AND A GUIDE DEVICE

(71) Applicant: Julius Blum GmbH, Hoechst (AT)

(72) Inventors: Florian FISCHER, Hoechst (AT); Gerhard KLEINSASSER, Dornbirn (AT); Hermann HAEMMERLE, Lustenau (AT); Matthias REISSIG, Lindau (DE); Alexander Simon FLOGAUS, Eriskirch (DE)

(21) Appl. No.: 19/354,207

(22) Filed: Oct. 9, 2025

Related U.S. Application Data
(63) Continuation of application No. PCT/AT2024/060130, filed on Apr. 10, 2024.

(30) Foreign Application Priority Data
Apr. 12, 2023 (AT) A 50257/2023

(51) Int. Cl. E05F 15/603; E05D 15/56; E05F 15/72

(52) U.S. Cl. CPC E05F 15/603; E05D 15/56; E05F 15/72; E05Y 2201/22; E05Y 2201/626; E05Y 2201/684; E05Y 2900/132; E05Y 2900/148

(57) ABSTRACT

An assembly includes a drive device, a component movable relative to a wall element and intended for closing an opening in the wall element, and a guide device, by which the component is movable relative to the wall element. The component is movable with respect to the guide device orthogonally relative to a longitudinal extent of the guide device by the drive device.

The present application is a continuation of International Application PCT/AT2024/060130 filed on Apr. 10, 2024. Thus, all of the subject matter of International Application PCT/AT2024/060130 is incorporated herein by reference.

### BACKGROUND OF THE INVENTION

The invention relates to an assembly comprising at least one, in particular exactly one and/or electrical, drive device, a component that can be displaced relative to a wall element, in particular a window or door or blind element, for closing an opening in the wall element, and at least one guide device with which the component can be displaced relative to the wall element. Furthermore, the invention relates to a method for displacing such an arrangement.

Such an assembly is already known from document EP 3 722 547 A1, wherein a sliding window can be displaced along a window frame by motor.

A disadvantage of the current state of the art is that the sliding window and the window frame are very thick due to the chosen design of the drive. In addition, the movement trajectory of the sliding window requires the window frame to be twice as wide as the sliding window. Furthermore, a large opening is required in the wall element, only half of which is accessible from the outside. Furthermore, there are steps in both the closed and open positions, which detract from the aesthetic appearance, require additional space, and tend to accumulate dirt.

### SUMMARY OF THE INVENTION

The objective technical task of the present invention is therefore to provide an improved assembly and an improved method compared to the prior art, in which the disadvantages of the prior art are at least partially eliminated and which are characterized in particular by a compact design and an efficient movement sequence.

According to the invention, the component can therefore be displaced orthogonally relative to a longitudinal extension of the at least one guide device by the at least one drive device.

This makes it possible for the component to be displaced parallel to the wall element to which the assembly can be mounted, for example to ventilate a room in a building, and/or subsequently, in a second movement section of the component, to enable displacement parallel to the wall element and orthogonal to the direction of the previous movement section, without ensuring collision with the wall element and ensuring clearance of the opening of the wall element.

The orthogonal displacement enables the component to be automatically displaced by the at least one drive device from a closed position parallel to the wall element and/or a plane spanned by two guide devices into a partially open position—in particular for ventilating a room or for positioning the component in a position in which the component can be displaced into the fully open position parallel to the at least one guide device outside the room.

In addition, there is the positive effect that at least one guide device can be concealed at least in some areas within the wall element and/or the component, so that a particularly visually appealing assembly can be provided, whereby the visual impression can be further improved by arranging the component flush with the wall element.

In this context, flush should be interpreted broadly enough to include even a slight protrusion of the component in the closed position—for example, from the facade. In the direction of the fully open position (after an orthogonal movement), the component can be displaced sideways along the facade. However, flushness can alternatively or additionally refer to the opening of the wall element, whereby in the closed state, preferably no guide (in relation to a component stack) must be visible.

However, the component is not limited to a (glass) window, and the assembly is not limited to use in wall elements, whereby the assembly can be sold separately and used in any area of application, for example as a blinding element in the form of a room divider or as a door, particularly a transparent one.

Wall elements (of rooms) can generally be understood to mean house walls, whereby roof walls of houses are included in house walls. In the functional position of the assembly, the component can cover the opening of the wall element in connection with a room of the house or similar.

It is particularly preferable that the component can be displaced orthogonally relative to a part of the guide device into a partial open position in the form of a state in which the component is displaced completely orthogonally to the wall element or the part of the guide device (parallel to the plane of the component). In general, starting from this orthogonally extended position, the component can then be displaced into a position oriented normally to this direction of movement and vice versa.

It is particularly preferable that, in a closed position of the component—especially when viewed orthogonally to the component—no guide rail of the at least one guide device is visible. The component may be frameless, whereby it is also possible to relocate the frame conventionally provided for the component to the wall element. Preferably, the component comprises a frame in order to enable an increase in thermal insulation properties and/or to conceal the movement technology.

The at least one drive device can assist the manual force of an operator of the component or perform a fully automated displacement of the component, at least in sections. The at least one drive device can ensure correct positioning of the component relative to the at least one guide device and/or—in particular remotely—block displacements of the component or—in particular automatically—initiate them. Preferably, the at least one drive device comprises an electric motor.

As stated at the outset, protection is also sought for a method of displacing such an assembly, wherein the component is displaced relative to the at least one guide device by the at least one drive device, wherein the component is displaced by the at least one drive device orthogonally to the longitudinal extension of the at least one guide device relative to the at least one guide device from a closed position into a partially open position or from a partially open position into a closed position to cover the opening of the wall element.

The partially open position can be defined, for example, by a state in which the at least one guide device is displaced completely orthogonally to its longitudinal extension. Analogous to a conventional window, this parallel open position corresponds to a tilt position, which must be performed manually to ventilate a room. According to the invention, an opening and/or closing process—preferably partial—can be performed by the at least one drive device, whereby additional functions, such as safety functions (child safety lock) or automation functions (restoration of desired air quality), can be performed flexibly and user-friendly via the at least one drive device or conditionally by a control and/or regulation device connected to it via a radio signal transmission or wired data connection.

According to an advantageous embodiment of the invention, the at least one guide device is arranged on an upper side and/or a lower side of the component in the position of use and/or the component can be displaced by the at least one drive device relative to the at least one guide device parallel to the longitudinal extension of the at least one guide device.

The assembly at the top or bottom enables lateral guidance of the component, whereby the front of the component is not impaired by the at least one guide device, and the at least one guide device can, for example, be concealed in a frame element so as not to reduce the transparency of the component in a central area.

By shifting parallelly to the longitudinal extension, the opening of the wall element can be largely freed up, whereby in particular no swiveling motion is necessary, so that the risk of falling out of the opening of the wall element is reduced and the accessibility of the component is designed to be particularly favorable throughout the entire movement sequence.

Advantageously, the component can be displaced parallelly along the longitudinal extension of the at least one guide device, preferably between a partially open position and a fully open position and/or at least 300 mm, particularly preferably at least 600 mm, and/or the component can be displaced substantially orthogonally to the longitudinal extension of the at least one guide device, preferably between a closed position and a partially open position and/or between 50 mm and 300 mm, particularly preferably between 100 mm and 150 mm.

It has proven advantageous that the at least one guide device for the relative displacement of the component relative to the wall element comprises a guide rail on the component side and/or a guide rail on the wall element side and/or that the at least one guide device is integrated at least in some areas in a component stock of the wall element and/or in a frame of the component. Preferably, the component-side guide rail is recessed in the component and/or the wall element-side guide rail is recessed in the wall element and/or the component is arranged substantially flush with the wall element in a closed position and/or the component is arranged parallel to the wall element in a partially open position and/or in a fully open position.

If the guide device is divided into two parts and one guide rail is assigned to the fixed wall element and one guide rail to the component, the component can be displaced laterally in a particularly favorable manner to expose the opening via hinges, whereby recessing the guide rails reduces contamination and creates a visually appealing impression, which is essential especially for windows or doors made of glass or plastic. A parallel arrangement requires only a small amount of space inside or outside the wall element, whereby a frame can be provided as a frame cover to conceal components of the movement technology.

It is particularly preferred that the component is arranged essentially flush with the wall element in the closed position and/or the fully open position and/or is arranged in the closed position and/or the partially open position with side surfaces essentially flush with a component layer of the wall element.

Preferably, the components required for guiding the component protrude transversely from the plane of the wall element so that essentially no components such as hinges need to protrude vertically upwards or downwards into the space defined by the component stock when in use, thereby forming a particularly compact guidance system.

According to an advantageous embodiment of the invention, the component can be displaced by the at least one drive device and/or manually relative to the at least one guide device, preferably between a closed position and a partially open position and/or between a partially open position and a fully open position. Preferably, the component can be locked in the closed position, in the partially open position and/or in the fully open position, particularly preferably by a bolt that can be swiveled into the at least one drive device and/or is arranged on a roller.

The at least one drive device can provide automated displacement of the component or reduce the force required to displace the component manually. The at least one drive device can drive the component in stages—for example, between the closed position and the partially open position—or transmit force until the component is fully open. It is also conceivable that the component can be displaced manually in a free-running range and, if necessary, be displaced automatically by the at least one drive device.

A locking mechanism for the at least one drive device is preferably generated by at least one bolt, whereby the number of bolts is generally arbitrary and other locking means are also conceivable. It is particularly preferable for at least one bolt to interact with a control cam of the at least one drive device in order, for example, to be able to ensure or inhibit varying movement trajectories of hinges or the component. For example, the relative positioning of the at least one locking means to a control cam or another locking means can block a first direction of movement for a hinge and enable a second direction of movement for the hinge, depending on the position of the hinge.

If at least one locking device is arranged on the roller, this roller can serve a dual function, for example, for the vertical synchronization of two guide devices. In general, any position of the component can be fixed by locking or clamping the at least one drive device and/or clamping or locking the component along the at least one guide device.

An advantageous variant of the present invention consists in the fact that the at least one drive device is coupled or can be coupled to a control and/or regulation device, preferably a building control system. Preferably, at least one sensor, particularly preferably a CO2 sensor system, is provided for measuring a property of a building and/or the at least one drive device can be activated by the control and/or regulation device, particularly preferably in dependence on a sensor signal from the at least one sensor.

For example, depending on lighting conditions, time of day, temperature, humidity, air quality, etc., a building control system can activate the at least one drive device to maneuver the component into a partially or fully open position in order to ventilate or provide a burst of fresh air to a room.

The type of sensor is generally arbitrary, whereby it is generally possible to dispense with a sensor and, for example, activate the at least one drive device at a predefined time by the control and/or regulation device. The control and/or regulation device can alternatively or additionally represent part of the at least one drive device or be integrated into it.

Preferably, the control and/or regulation device comprises a computing unit, a memory unit, a receiving unit, and/or a data transfer module, whereby, for example, an algorithm stored in a computer program product may be provided for controlling or regulating the at least one drive device.

It is particularly preferred that the at least one drive device can be operated manually and/or is designed in the form of a crank, or that at least one switch, preferably a radio switch and/or control switch, is provided with which the at least one drive device can be activated.

A manual force can be transmitted to the at least one guide device via a crank—for example, in conjunction with a cable pull—or similar. Alternatively or in addition, the component may comprise a handle for manual displacement. Preferably, the component is displaced by means of an electric drive device, although other drive mechanisms are also possible.

The at least one switch (arranged, for example, on the at least one guide device and/or on the wall element) can be used to activate the at least one drive device remotely or at a specific position, for example the partially open position.

In one embodiment of the invention, the at least one drive device is arranged in the area of a corner of the component or at a central area of a side surface of the component, whereby it is preferably provided that two drive devices are arranged diagonally in the area of two corners of the component.

A drive device is sufficient for an opening and closing displacement of the component, whereby positioning the drive device in the corner area of the component facilitates maintenance and installation. If the drive device is positioned on the outside of the at least one guide device, collisions with moving components are reduced, whereby the drive device can also be concealed within the wall element.

According to a preferred embodiment of the invention, the at least one drive device interacts with at least one hinge, preferably comprising two toggle levers, wherein preferably four hinges are provided in the area of four corners of the component and/or two hinges are arranged on a component stock, if present, and/or two further hinges are arranged on the component and/or a movement of at least two hinges in the operating position of the assembly is synchronized horizontally and/or vertically and/or a toggle lever is provided to compensate for a weight load of the component and a further toggle lever is provided to guide the component.

A hinge with at least one toggle lever has proven to be particularly effective for efficient displacement of the component, whereby a toggle lever can be understood as an articulated connection via a knee joint. The hinge can-especially with at least two toggle levers-comprise different functions, such as load transfer, lateral guidance, or orthogonal movement, etc. Two toggle levers can be arranged on the same hinge or separately on two hinges, whereby it is generally conceivable to provide only one toggle lever or to design the hinge without a toggle lever.

It has proven advantageous to have at least one hinge fixed to the wall element-side guide rail and at least one hinge fixed to the component-side guide rail, so that the component-side guide rail can move relative to the wall element-side guide rail.

This allows a component-side guide rail to be displaced together with the component in a particularly stable, secure, and harmonious manner relative to a fixed wall-side guide rail.

Furthermore, preferably exactly one drive device and two or four hinges are provided, and the at least one drive device is arranged on one of the two or four hinges and one of the two or two of the four hinges is/are movable relative to the other hinge or the other two hinges by the at least one drive device.

In a further embodiment, two horizontally oriented synchronization rods, preferably mounted so as to be movable, may be provided in the operating position. A cable comprising a figure-eight loop is provided for synchronizing at least two hinges, preferably arranged in a form-fitting manner on the synchronization rods, for counter-rotating the synchronization rods, preferably between 90° and 150°, and/or the at least one hinge comprises a running carriage. Preferably, two running carriages can be displaced on the guide rail on the component side, if present, and/or two running carriages can be displaced on the guide rail on the wall element side, if present.

The synchronization rods serve to synchronize the vertical displacement of the component. In general, it is conceivable to provide only one synchronization rod, to arrange the synchronization rod(s) vertically, or to decouple the hinges or the cable from the synchronization rods or to provide other synchronization means.

According to an advantageous embodiment of the invention, the at least one hinge is oriented at an angle to compensate for tilting or lowering of the component relative to a vertical of the operating position and/or comprises a cable pull to compensate for tilting of the component relative to a horizontal of the operating position. Preferably, the cable pull comprises a conical drum for shortening a cable length and/or a position-adjustable deflection roller.

In the partially or fully open position, the component may tend to sag or tilt due to gravity, whereby a hinge axis of a toggle lever counteracts tilting or sagging of the component from the closed position to the partially open position by means of an inclination.

The cable pull may be designed for load transfer due to the displacement movement and may be designed in such a way that an increasing moment is compensated for as the opening movement progresses.

Lowering or tilting of the component can be prevented by the orientation of the hinge and/or by a cable pull or similar, or even overcompensated by lifting the component.

In a preferred embodiment, a bending movement of a toggle lever of the at least one hinge can be locked from a partially open position in the direction of a fully open position and/or a clamping lever, preferably coupled to a brake, is provided, with which the at least one hinge can be automatically locked at any position between the partially open position and the fully open position. The component can be displaced along the at least one guide device by actuating the clamping lever, wherein preferably the clamping lever comprises a handle which can be retracted at least in some areas in a frame of the component, if present, and/or can be adjusted discretely or continuously.

By locking the bending movement, either as an alternative or in addition to locking at least one drive device (for example, via the power supply or deactivation or a lock with a bolt), burglary protection can be ensured in the closed position and/or buckling of a hinge can be prevented when the component is displaced parallel into the fully open position.

A brake can increase the service life of the assembly by preventing abrupt, position-secure fixation of the component. The handle can be used to release a jam or the brake so that the component can be displaced manually or with the aid of at least one drive device. The automatic jamming of the component prevents the component from being displaced sideways in an undesirable manner, for example by wind.

It is particularly preferred that at least one switch and/or at least one sensor system, preferably a metal detector, is provided, by which a partially open position of the component can be detected and/or by means of which, preferably depending on detection of the partially open position starting from a fully open position, at least one drive device can be activated and/or, preferably, depending on detection of the partially open position starting from a closed position, at least one drive device can be deactivated. Preferably, the at least one switch and/or the at least one sensor system can be actuated by a running carriage, if present, of a guide rail on the wall element side.

This allows automated transfer to the closed position to be followed by manual transfer to the partially open position. For example, a jam protection device may be provided to protect an operator. The at least one drive device can be activated or deactivated when it enters the partially open position via a drive control or a power supply for the at least one drive device.

Preferably, the at least one drive device is locked and/or coupled to a control and/or regulation device, and the at least one drive device is activated by the control and/or regulation device, preferably depending on a sensor signal from at least one sensor.

Preferably, the component, preferably via the at least one drive device, is displaced parallel to the longitudinal extension of the at least one guide device from the partially open position to a fully open position to expose at least part of the opening orthogonally to the opening, or from the fully open position to the partially open position.

Preferably, the partially open position be detected by at least one switch and/or at least one sensor system, preferably direction-dependent and/or via at least one running carriage, whereby the at least one drive device is activated or deactivated.

### BRIEF DESCRIPTION OF THE INVENTION

Further details and advantages of the present invention will be explained in more detail below with reference to the drawings, in which:

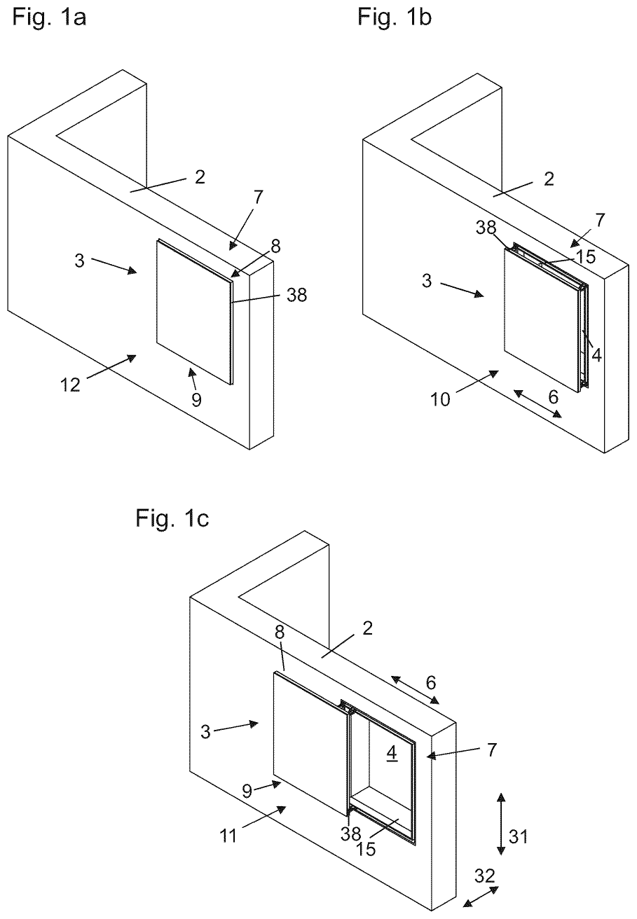

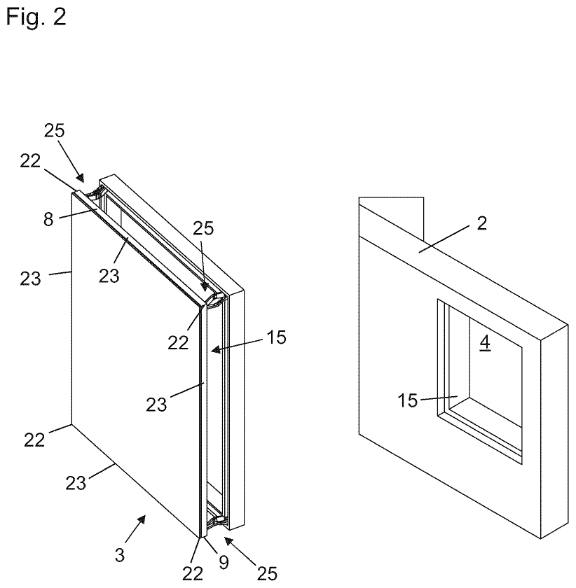

FIG. 1a-1c show an assembly according to the invention in accordance with a preferred embodiment arranged on a wall element in three different states in perspective view,

FIG. 2 shows a component of the assembly according to the embodiment shown in FIG. 1a, decoupled from the wall element in perspective view,

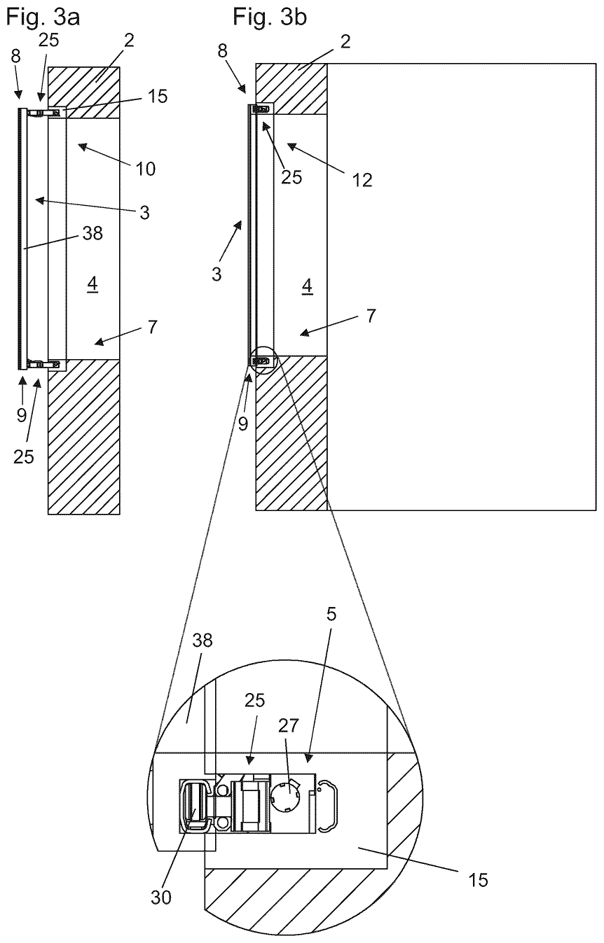

FIG. 3a, 3b show the assembly according to the embodiment shown in FIGS. 1b and 1a in sectional view with enlarged detail in the area of a guide device,

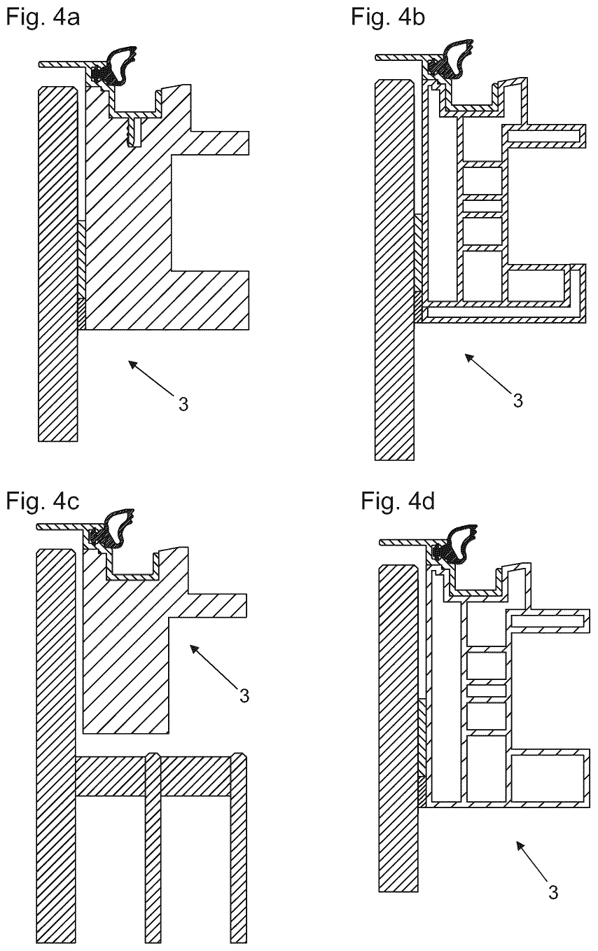

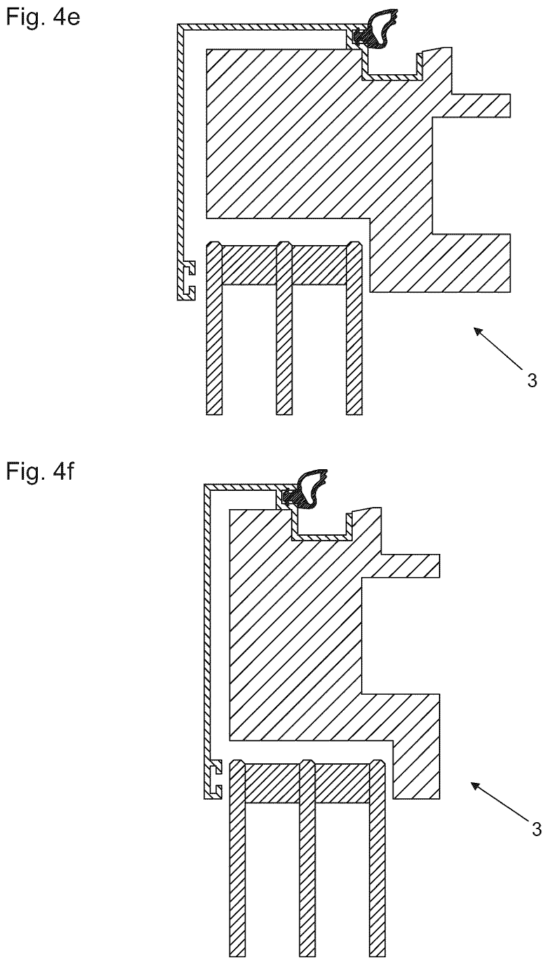

FIG. 4a-4f show a component for an assembly according to the embodiment shown in FIG. 1c in different configurations, each shown in sectional view,

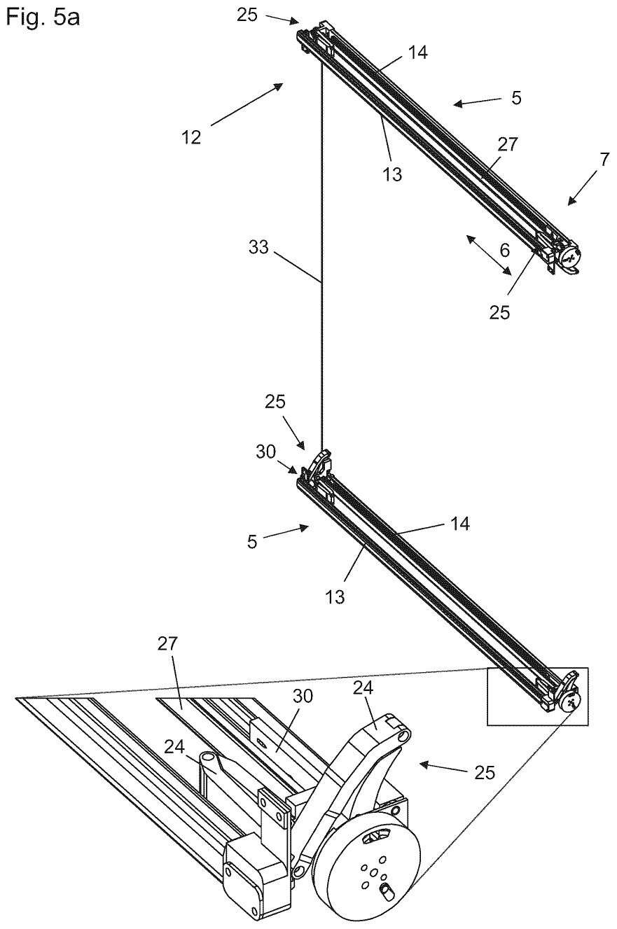

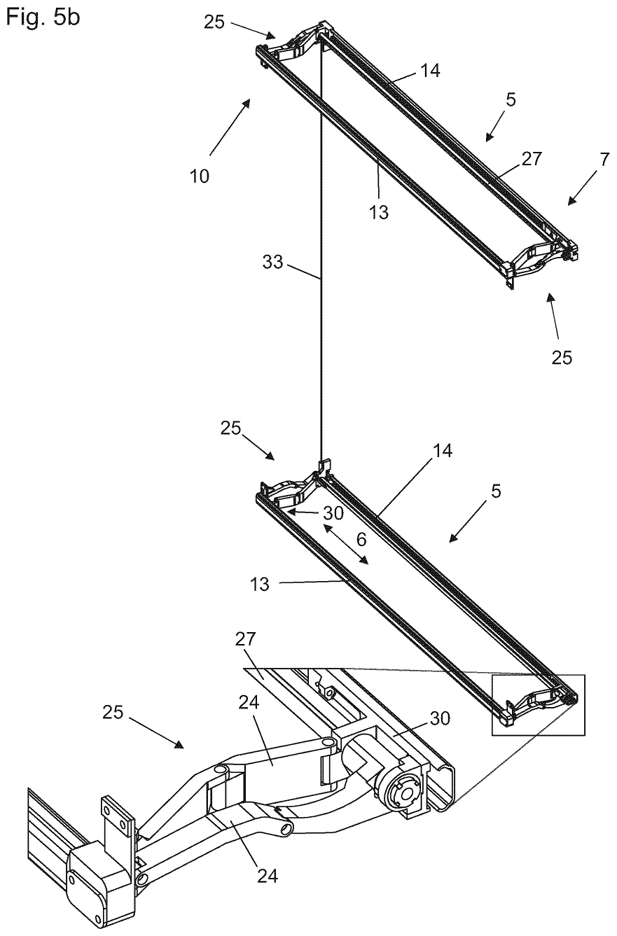

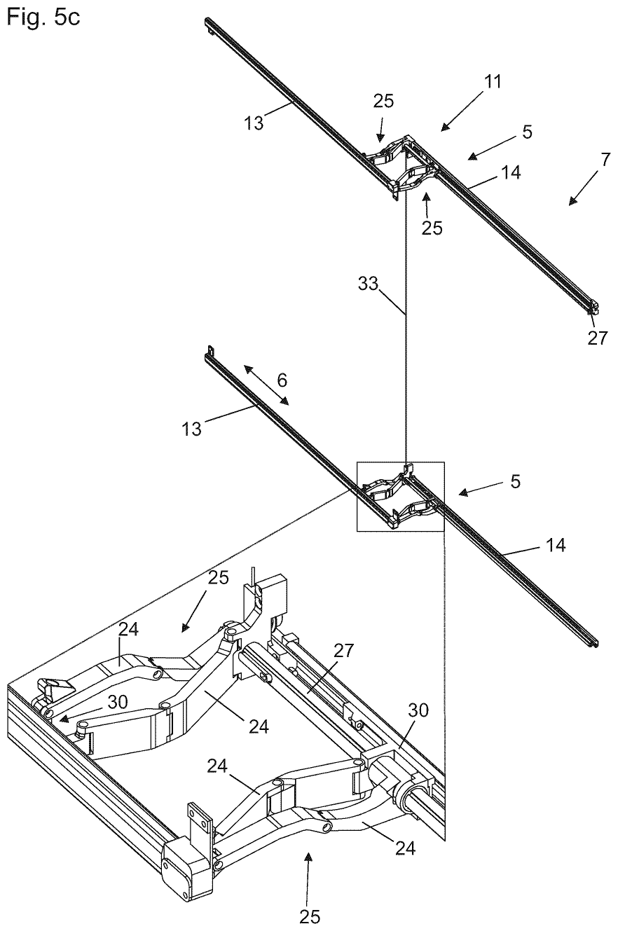

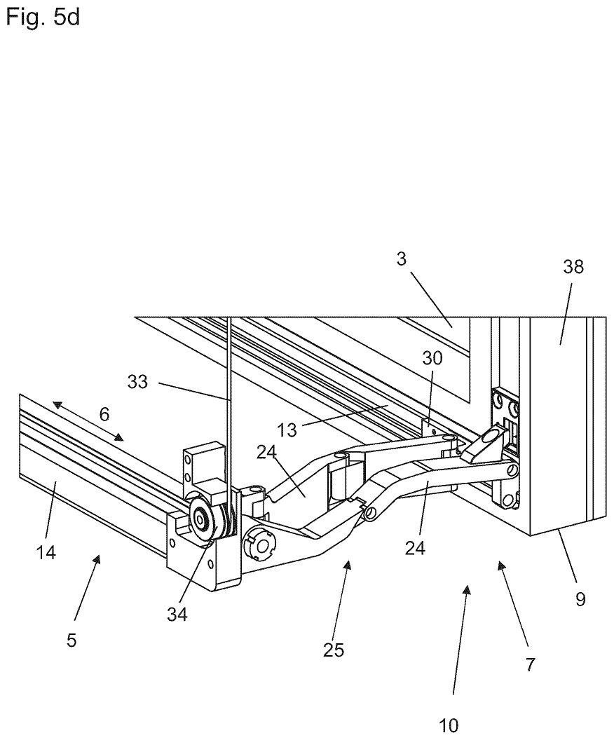

FIG. 5a-5d show a guide device for an assembly according to the embodiment shown in FIG. 1c in different positions with enlarged detail sections in the area of hinges, shown in perspective,

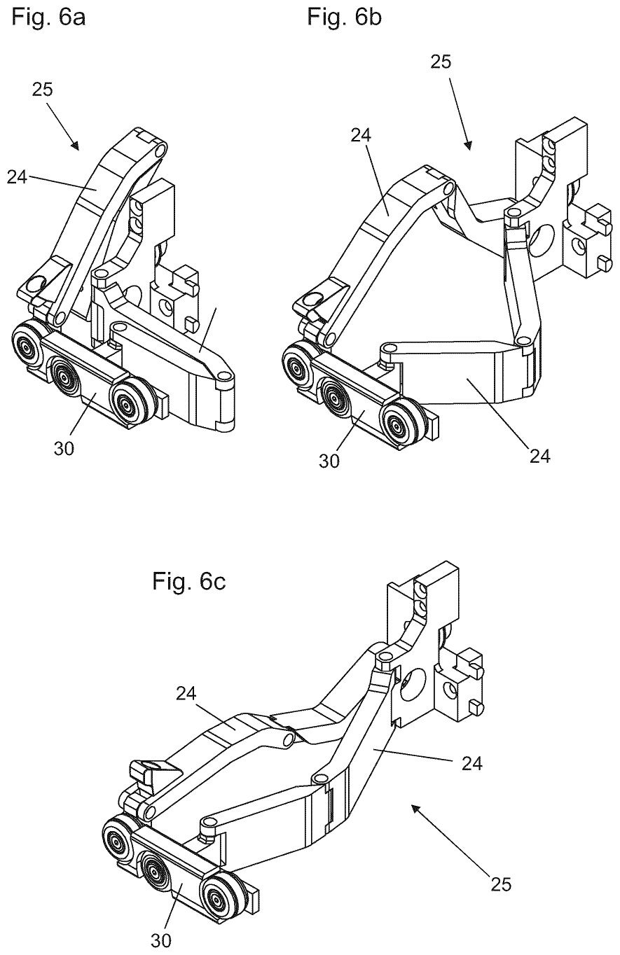

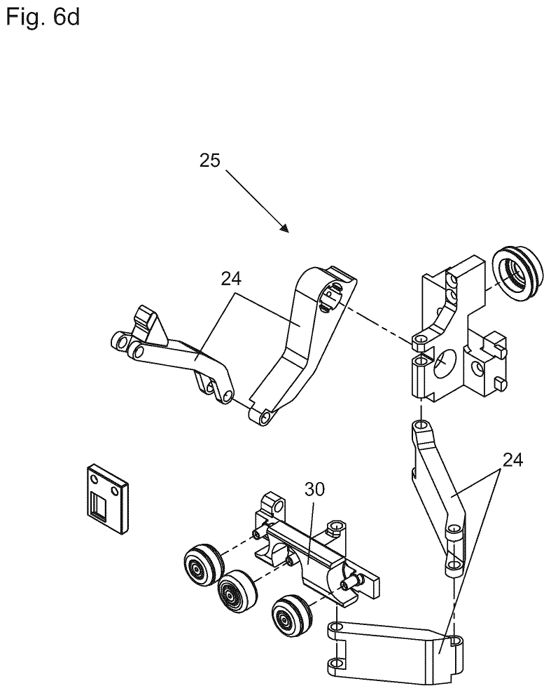

FIG. 6a-6d show a hinge for a guide device according to the embodiment shown in FIG. 5d in three perspective views and an exploded view,

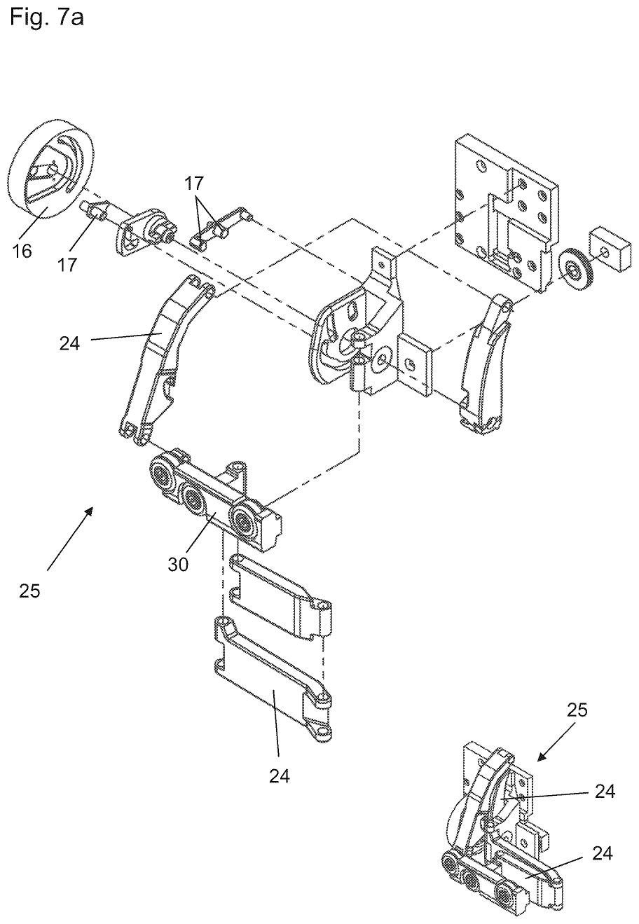

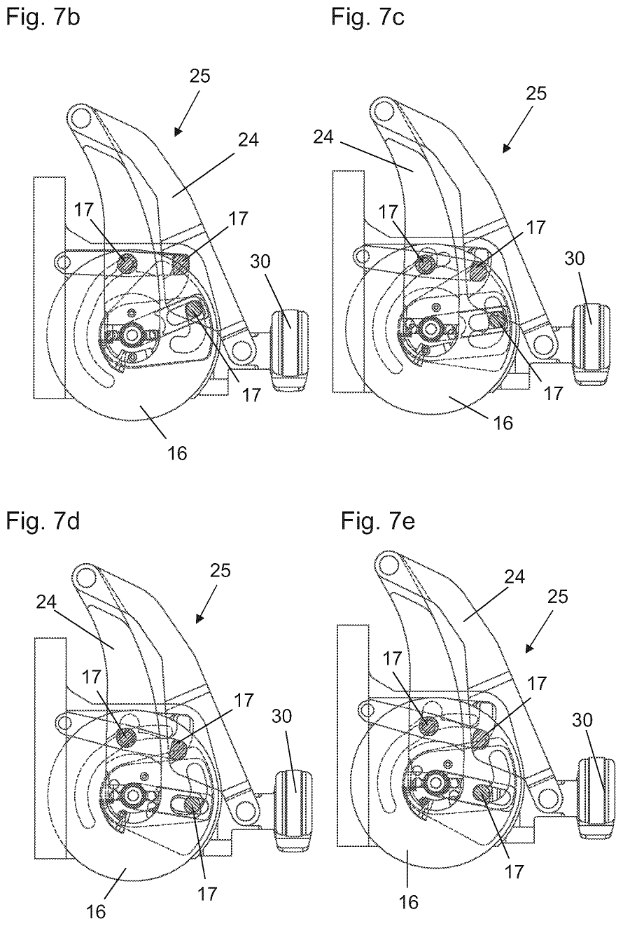

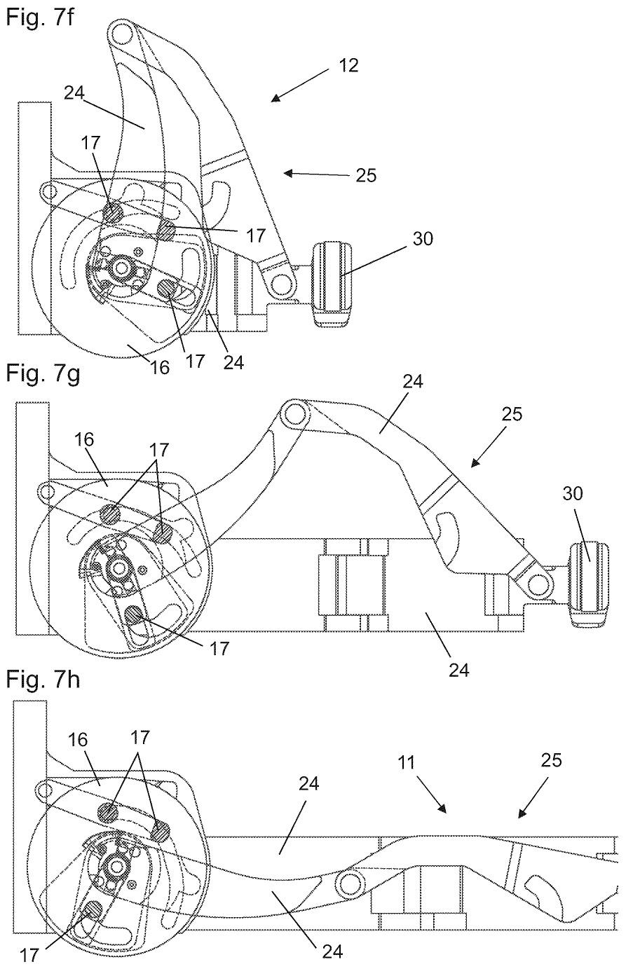

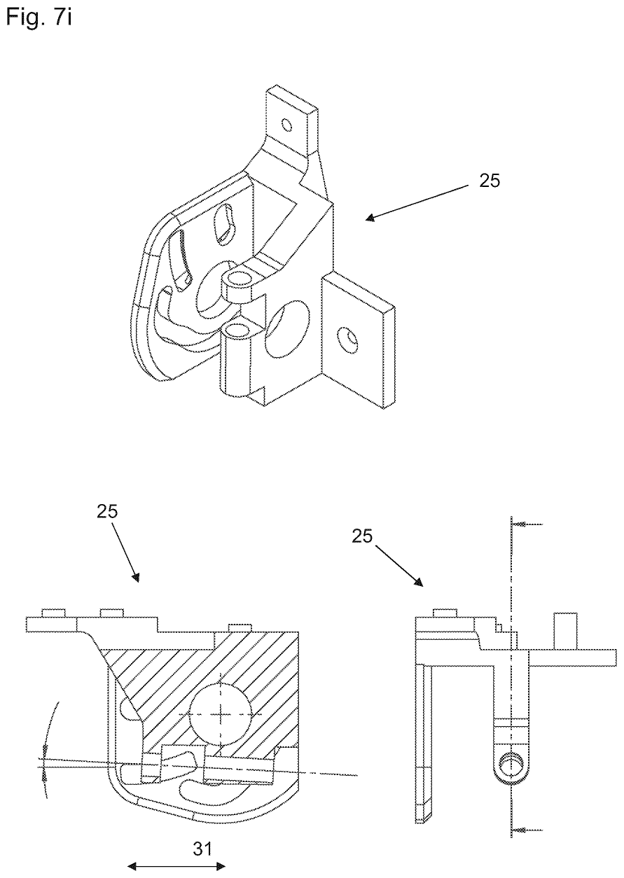

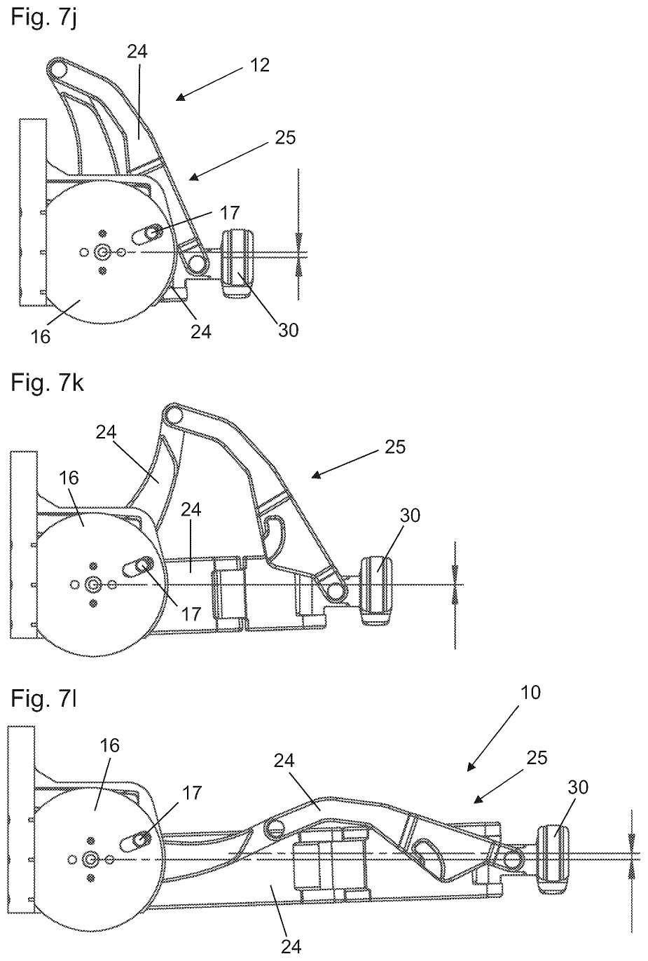

FIG. 7a-7l show the hinge according to the embodiment shown in FIG. 6a in an exploded view and side views illustrating preferred displacement trajectories,

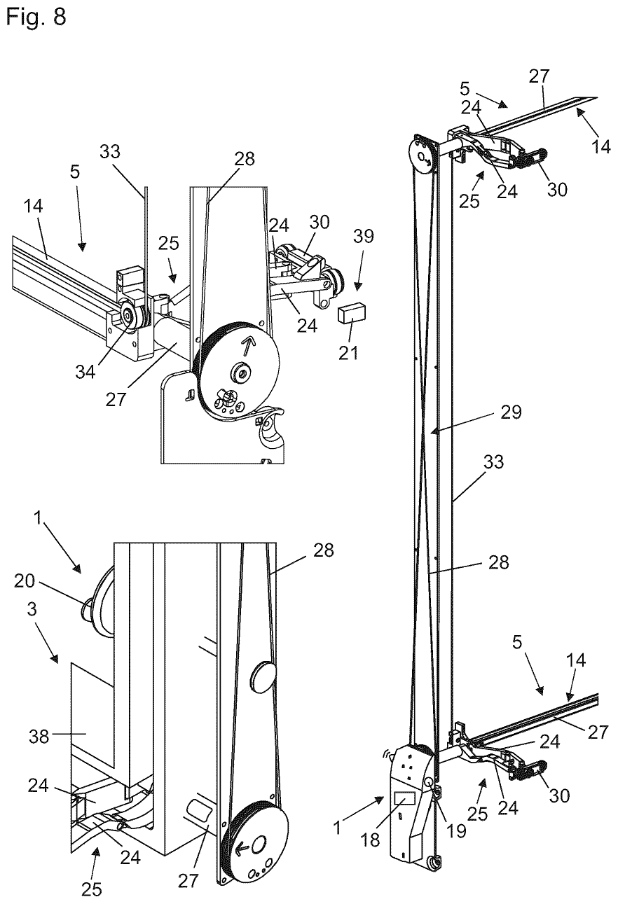

FIG. 8 are perspective views of component parts in connection with a drive of the assembly,

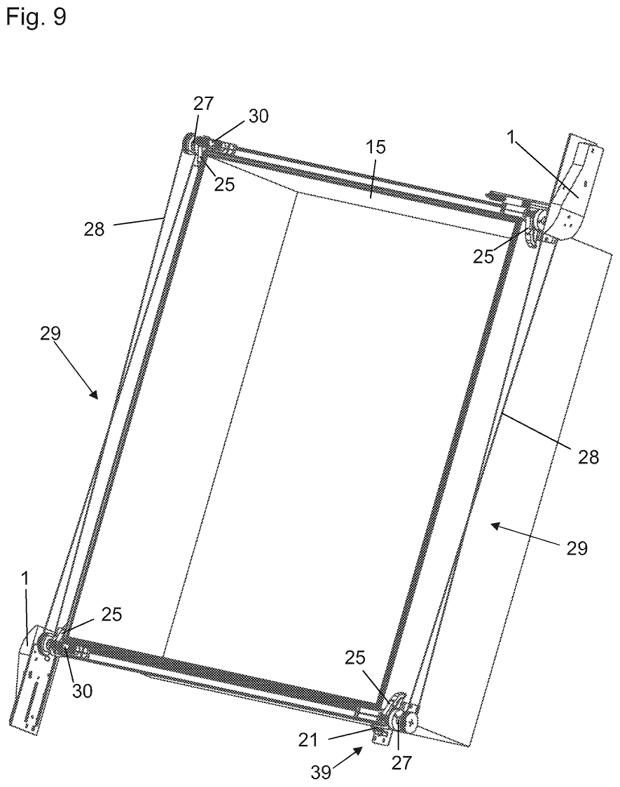

FIG. 9 show two electric drive devices for moving the component along the guide devices in perspective view,

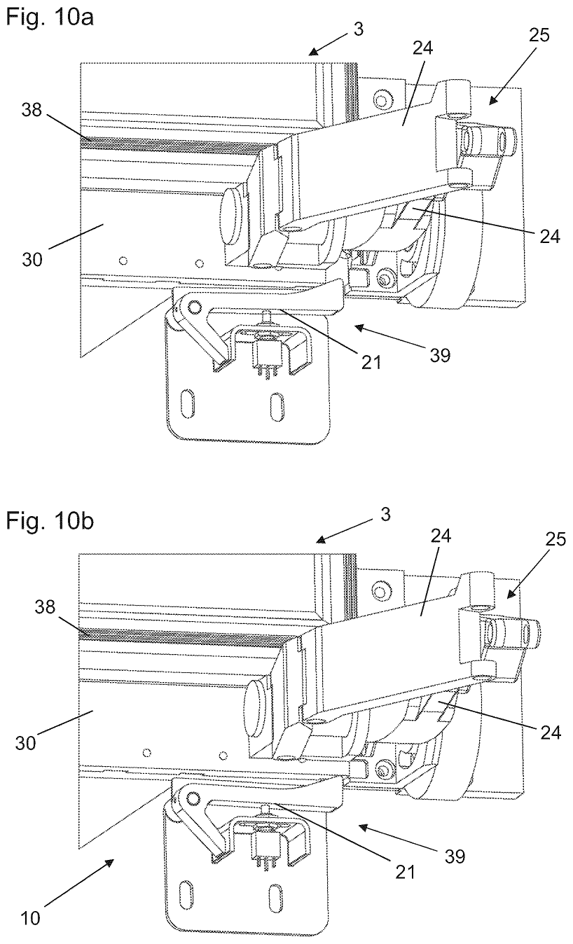

FIG. 10a, 10b is an enlarged view of a component in the form of a window in the closed position in the area of a hinge with two toggle levers in perspective view,

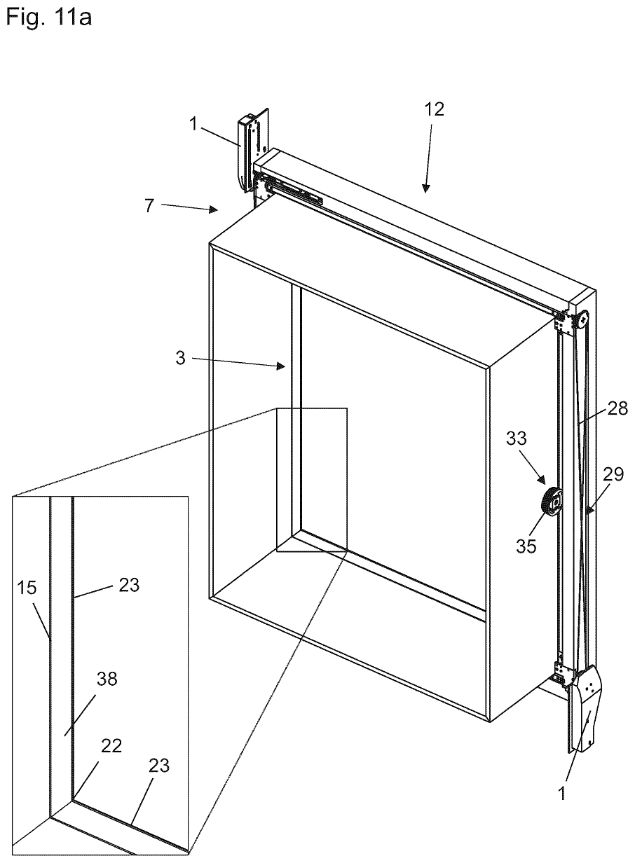

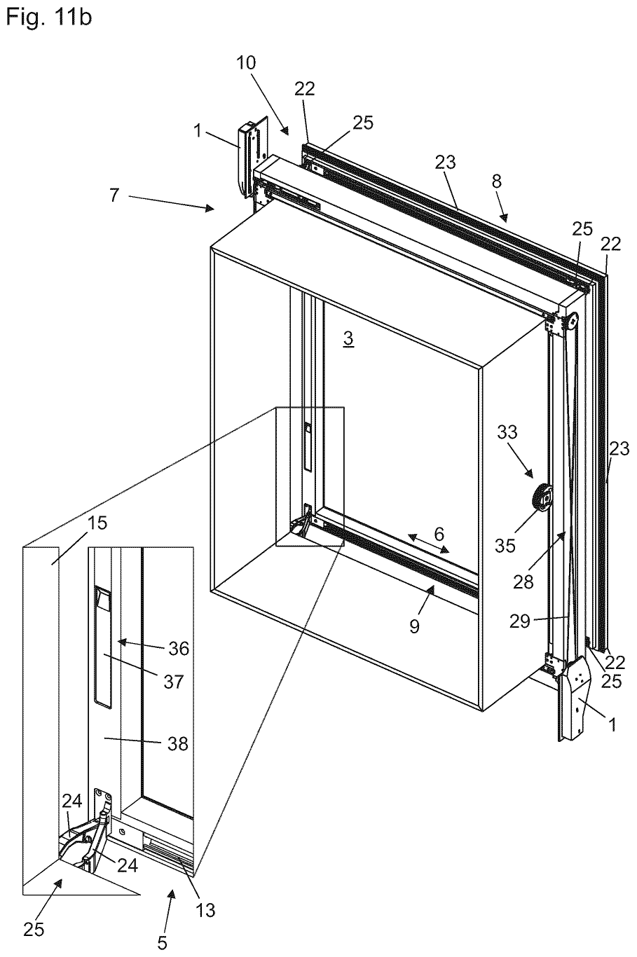

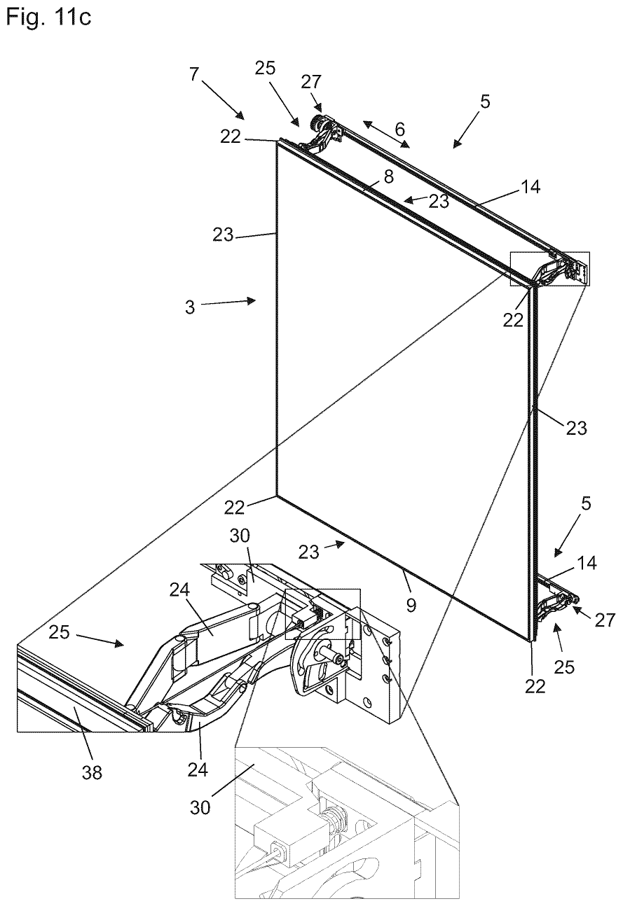

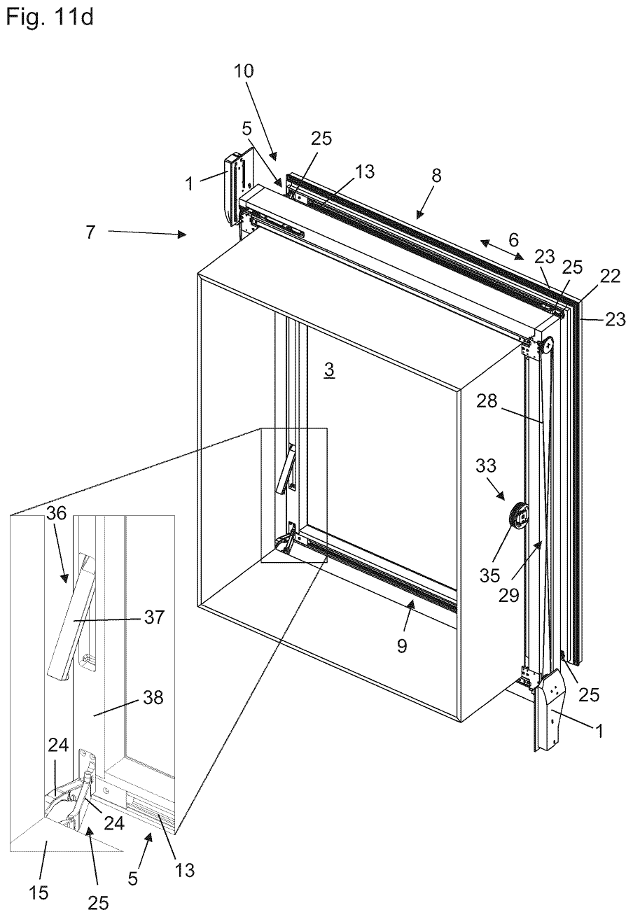

FIG. 11a-11d show a preferred assembly with hidden parts and, when assembled, for installation in a wall element in perspective views, and

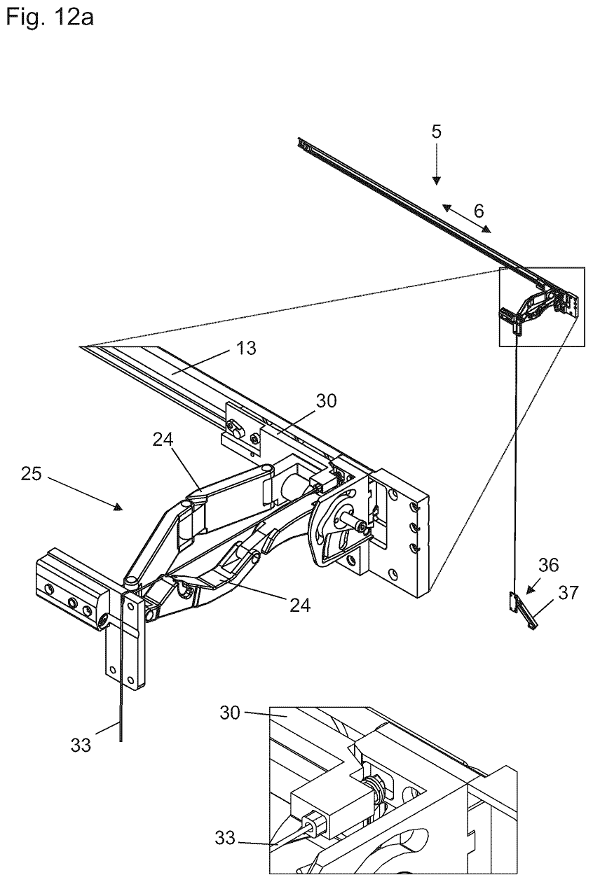

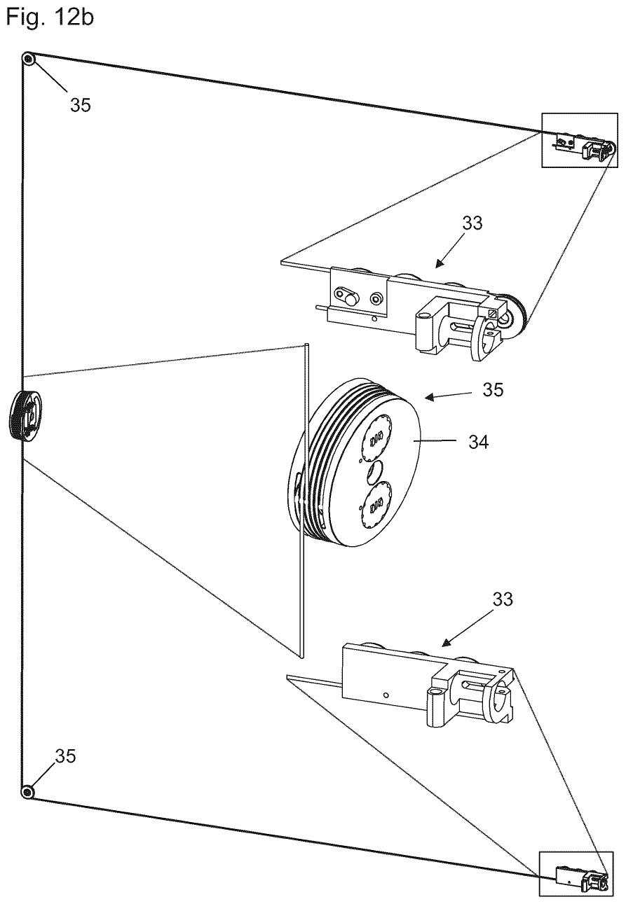

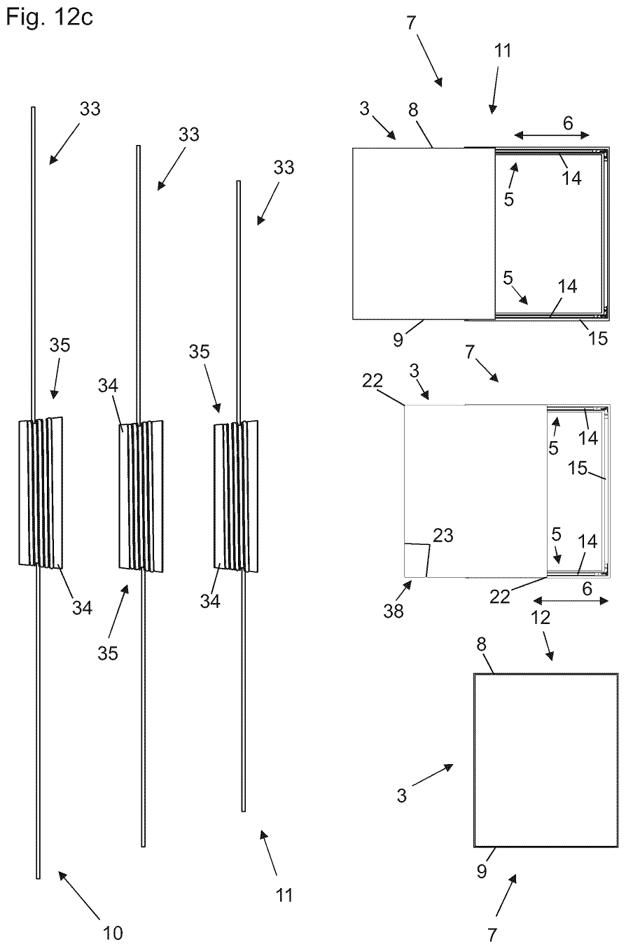

FIG. 12a-12c show component parts for synchronization and tilting moment compensation for an assembly according to the embodiment shown in FIG. 1c in different representations.

### DETAILED DESCRIPTION OF THE INVENTION

FIGS. 1a to 1c show three preferred positions of an assembly in the operating position 7, wherein the positioning of the assembly in FIG. 1a corresponds to a closed position 12, in FIG. 1b to a partially open position 10, and in FIG. 1c to a fully open position 11.

The assembly comprises an electric drive device 1 (see 8), a component 3 in the form of a window that can be displaced relative to a wall element 2 for closing an opening 4 in the wall element 2, and two guide devices 5 with which the component 1 can be displaced relative to the wall element 2 to expose or cover the opening 4.

FIG. 2 shows the assembly prior to mounting on the wall element 2, wherein the guide devices 5 for the relative displacement of the component 3 relative to the wall element 2 comprise a guide rail 13 on the component side and a guide rail 14 on the wall element side.

The guide rail 14 on the wall element side is integrated into a component stock 15 for connecting the wall element 2, and the guide rail 13 on the component side is integrated into a frame 38 of the component 3 and recessed therein.

The component 3 can be arranged essentially flush with wall element 2 in the closed position 12 and parallel to wall element 2 in the partially open position 10 and in the fully open position 11.

FIGS. 3a and 3b show sectional views of the partially open position 10 and the closed position 12 of component 3 relative to the guide devices 5.

The enlarged detail shows that two horizontally oriented synchronization rods 27 mounted on sliding bearings are provided in the operating position 7.

FIGS. 4a to 4f show possible designs for the component 3 in the form of a window, although other designs or material combinations are also possible in order to reduce thermal conductivity and/or thermal bridges.

FIG. 4a shows a design with vacuum insulating glass with a wooden frame connected to an aluminum profile. FIG. 4b shows vacuum insulating glass attached to an aluminum profile without any wood-like materials. In FIG. 4c, the component 3 comprises stepped rebate glass in combination with wood and aluminum. FIG. 4d shows vacuum insulating glass connected to a plastic profile and an aluminum profile. FIG. 4e and FIG. 4f show multi-pane insulating glass arranged on wood and aluminum with different geometries for connection to a guide device 5.

FIG. 5a shows the guide devices 5 isolated in the closed position 12, wherein the synchronization rods 27 are mounted in a fixed bearing of hinges 25 on the wall element side so that they can be displaced, although this is not absolutely necessary.

The drive device(s) 1 (see FIG. 9) interact with four hinges 25, each comprising two toggle levers 24.

FIG. 5b shows the guide devices 5 in a partially open position 10, whereas FIG. 5c shows the guide devices 5 in a fully open position 11 of component 3.

FIG. 5c shows, in comparison to FIG. 5b, that two hinges 25 are fixed to the wall element-side guide rail 14 and two hinges 25 are fixed to the component-side guide rail 13, so that the component-side guide rail 13 is movable relative to the wall element-side guide rail 14, wherein two hinges 25 are displaceable relative to two hinges 25.

FIG. 5d shows an enlarged view of a guide device 5 connected to the component 3, wherein the guide rail 13 on the component side is movable parallel to the guide rail 14 on the wall element side.

FIG. 6a shows a hinge 25 in the closed position 12, which is displaced via the relative arrangement of the two toggle levers 24 in FIG. 6b into the position shown in FIG. 6c of the partially open position 10 and the fully open position 11 in order to be able to displace the component orthogonally and parallel relative to the guide device 5.

The hinge 25 comprises a running carriage 30, whereby generally two running carriages 30 are movable on the component-side guide rail 13 and two running carriages 30 are movable on the wall element-side guide rail 14.

FIG. 6c shows the hinge 25 in an exploded view, wherein two articulated levers are connected to each other via an articulated connection for each toggle lever 24.

FIG. 7a shows an exploded view of a hinge 25 with component parts involved in locking or blocking the hinge 25.

The three bolts 17 can be used to lock or release the movement of the hinges 25 or the transmission of movement by the drive device 1 via corresponding control cams for the bolts 17. The hinge comprises three control cams with individual curvature.

A bolt 17 is pivotably arranged on a roller 16, wherein the roller 16 is also used to synchronize the assembly.

The component 3 can be locked in the closed position 12 to provide burglary protection. The component 3 can be locked in the partially open position 10 to ensure that a room can be ventilated without completely exposing the opening 4. The component 3 can be locked in or before the fully open position 11 to prevent wind-induced or unintentional displacement of component 3.

FIG. 7b to FIG. 7e show the movement trajectories of the bolts 17 to release the toggle levers 24 for extension from the folded position, whereby the three bolts 17 perform different swivel movements relative to each other along the control cams.

FIG. 7f to FIG. 7h show a hinge 25 being extended via the two toggle levers 24, whereby the bolt 17 arranged on the roller 16 is displaced along with it during the extension. The bolts 17 can then be displaced back to their starting position in order to repeat the displacement sequence, whereby, for example, the roller 16 is rotated in the opposite direction, but the bolts 17 can be displaced further into their previous position via the control cams.

A bending movement of a toggle lever 24 of the hinge 25 can be locked for parallel displacement along the guide devices 5 from the partially open position 10 in the direction of the fully open position 11.

FIG. 7i shows a base body of the hinge 25, wherein the hinge 25 is inclined relative to a vertical 31 of the operating position 7 via a bore arranged at an angle relative to the vertical 31 in order to compensate for tilting or lowering of the component 3.

The joint axis bore, which is inclined relative to the vertical 31, prevents the component 3 from sagging due to gravity from the closed position 12 to the partially open position 11. The hinge axis of a toggle lever 24 of the two hinges 25 to be connected to a component stock 15 on the wall element side is thus slightly inclined relative to the vertical 31.

In FIG. 7j to FIG. 7l, the hinge 25 is shown without the weight of the component 3, whereby the component 3, due to the inclination of hinge 25 starting from FIG. 7j in the closed position 12, raises the hinge 25 in the partially open position 10 in FIG. 7l via the intermediate position in FIG. 7k, whereby the vertical distance generated by this is elastically deformed to 0° by the mass of the component 3, if necessary.

FIG. 8 shows the component parts relevant for driving the component 3, with the view on the right showing a drive device 1, which is designed as an electric drive device 1. In general, no further drive device 1 is required.

The component 3 can be displaced orthogonally relative to a longitudinal extension 6 (see FIG. 5c) of the guide device 5 by the drive device 1.

In this embodiment, the component 3 can be displaced by the drive device 1 relative to the guide device 5 between the closed position 12 and the partially open position 10 and can be manually displaced between the partially open position 10 and the fully open position 11.

The drive device 1 is coupled to a control and/or regulation device 18 on the drive device 1, whereby the control and/or regulation device may alternatively or additionally be in the form of a spatially separate building control system.

The assembly comprises a sensor 19 in the form of a CO2 sensor for measuring air quality in a building (other properties such as temperature or humidity are also possible).

The drive device 1 can be activated by the control and/or regulation device 18 depending on a sensor signal from the sensor 19, but can generally also be activated, for example, depending on time or based on lighting conditions. The input signal for activating the drive device is generally arbitrary.

For example, this may be a drive device 1 for interacting with two or four hinges 25, wherein the drive device 1 is arranged on one of the two or four hinges 25 and one of the two or two of the four hinges 25 is movable by the drive device 1 relative to the other hinge 25 or the other two hinges 25.

At the bottom left, a manual drive device 1 in the form of a crank 20 is provided as an alternative.

A switch 21 for activating the drive device 1 is shown schematically at the top left, which can generally also be arranged, for example, on the wall element 2 as a radio switch or on the control and/or regulation device 18 as a control switch. Activation can be wired but is preferably carried out via radio. The drive device 1 comprises a receiving device for this purpose, whereby the drive device 1 can comprise a data transfer module with which information such as operating time, movement data or the like can be transferred to an electronic means for evaluation.

The switch 21 can, for example, also be arranged on the guide device 5 or be provided as sensor technology 39 in the form of a metal detector in order to detect a partially open position 10 of the component 3 and, for example, to inform the control and/or regulation device 18 or the drive device 1 directly via the detection in the form of a digital data record. It is preferred that the switch 21 or the sensor technology 39 can be actuated by a running carriage 30 (the wall element-side guide rail 14).

The drive device 1 can be activated depending on detection of the partially open position 10 starting from a fully open position 11 and can be deactivated depending on detection of the partially open position 10 starting from a closed position 12.

FIG. 9 shows that, in order to synchronize the two hinges 25 arranged in a form-fitting manner on the synchronization rods 27, a cable 28 comprising a figure-eight cable 29 is provided for rotating the synchronization rods 27 in opposite directions.

In this embodiment, two cables 28 are provided on opposite sides of the guide devices 5, although this is not absolutely necessary. The synchronization rods 27 rotate approximately 120° during use.

The toggle lever 24, which is intended for the guide function, is positively locked and, in the case of the component-side guide rail 13, is connected to the synchronization rods 27 in a manner that allows it to be displaced.

Two hinges 25 are arranged on a component stock 15 and two further hinges 25 are arranged on the component 3, whereby movement of the hinges 25 in the operating position 7 of the assembly is synchronized horizontally and vertically.

A toggle lever 24 of the respective hinge 25 is provided to compensate for a weight load of the component 3, and a further toggle lever 24 of the respective hinge 25 is provided to guide the component 3.

A sensor technology 39 for detecting the partially open position 10 is arranged at the bottom right of the illustration and is designed as a switch 21. The mode of operation during entry into the partially open position 10 can be seen in FIGS. 10a and 10b. Alternatively or in addition, the partially open position 10 can be determined by a switch 21 or a sensor technology 39, for example via a rotational position of a component, such as the synchronization rod 27.

FIG. 10a and FIG. 10b show an enlarged view of the hinge 25 connected to the component 3 in the form of a window before the transition (generally from the closed position 12 or the fully open position 11) to the partially open position 12 in a folded position.

The sensor technology 39 comprises the switch 21, which in FIG. 10a interrupts or maintains the power supply to the drive device (depending on the direction of entry into the partially open position 10). In FIG. 10b, the component 3 is located in the partially open position 10, so that the switch 21 of the sensor technology 39 establishes or interrupts the power supply to the drive device via a tilting movement caused by the displacement of a running carriage 30 and preferably via an electrical contact element. In general, the sensor technology 39 or the switch 21 can be designed to activate the control and/or regulation device 18 of the drive device 1 or the drive device 1 itself.

FIG. 11a shows the closed position 12 of the component 3 on the component stock 15, wherein a cable pull 33 is provided to compensate for any tilting of the component 3 relative to a horizontal plane 32 in the operating position 7.

In FIG. 11b, the component 3 was displaced to the partially open position 10 by orthogonal parallel displacement of at least 50 mm, whereby the component 3 can then be displaced parallel along the longitudinal extension 6 of the guide devices 5 by at least 600 mm.

The enlarged detail shows that a clamping lever 36 coupled with a brake (not shown for clarity) is provided, with which the hinges 25 can be automatically clamped in any position between the partially open position 10 and the fully open position 11, whereby the component 3 can be displaced along the guide devices 5 by actuating the clamping lever 36.

The clamping lever 36 comprises a handle 37 which can be retracted into a frame 38 of the component 3. The clamping lever 36 can be designed to be adjustable either discretely or continuously.

FIG. 11c shows the component 3 with the guide devices 5, whereby the enlarged detail sections show the connection of a hinge 25 to the surrounding components of a guide device, which are driven by the drive device 1 and can be displaced manually.

The guide devices 5 are arranged in the operating position 7 on an upper side 8 and a lower side 9 of the component 3, wherein the component 3 can be displaced by the drive device 1 relative to the guide devices 5 parallel to the longitudinal extension 6 of the guide devices 5.

The four hinges 25 are provided in the closed position 12 and partially open position 10 in the area of four corners 22 of the component 3, whereby in the fully open position 11 two hinges 25 are movable along two side surfaces 23 of the component.

FIG. 11d differs from FIG. 11b only in that the clamping lever 36 has been moved to a position in which the component 3 can be displaced sideways from the current partially open position 10 toward the fully open position 11.

The two drive devices 1 are each arranged in the area of a corner 22 of the component 3, whereby the two drive devices 1 are arranged diagonally in the area of the two corners 22 of the component 3. An arrangement at a central area of a side surface 23 of the component 3 is also conceivable.

FIG. 12a shows that the clamping lever 36 is connected to a guide device 5 via a cable, so that when the clamping lever 36 is actuated, the automatic fixing of the component 3 to the guide device 5 for moving the component 3 is released. Clamping can generally be achieved by form fit and/or force fit.

FIG. 12b shows the cable pull 33 shown in isolation, wherein the cable pull 33 comprises a conical drum 34 for shortening a cable length and two position-adjustable deflection rollers 35. The conical drum 34 can also be regarded as a deflection roller 35.

FIG. 12c shows the shortening of the cable length when the component 3 is in different positions along the guide devices 5.

The cable length of the cable pull 33, which is not assigned to the conical drum 34, is longest in the left-hand illustration, which corresponds to the closed position 12 of the component in the lower illustration. Via the intermediate position (corresponding to the center illustration of the conical drum 34 and the middle illustration of the component 3), the component moves to the fully open position 11 (upper illustration of the component 3), whereby the cable length of the cable pull 33, which is not wound onto the conical drum 34, is shortened (right illustration of the conical drum 34), so that sagging or tilting of the component 3 is prevented.

An exemplary method for displacing an assembly can be illustrated as follows: Component 3 is displaced relative to guide device 5 by means of drive device 1, whereby component 3 is displaced by the drive device 1 orthogonally to the longitudinal extension 6 of the guide device 5 relative to the guide device 5 from the closed position 12 to the partially open position 10 to expose the opening 4 of the wall element 2, or vice versa to completely cover the opening 4. The component 3 is displaced manually or via the drive device 1 parallel to the longitudinal extension 6 of the guide device 5 from the partially open position 10 into the fully open position 11 to expose the opening 4 orthogonally to the opening 4 or vice versa to partially cover the opening 4.

The drive device 1 can, for example, be locked in the closed position 12 and coupled to a control and/or regulation device 18 in such a way that the drive device 1 is driven by the control and/or regulation device 18 in response to a sensor signal from the sensor 1 or regulating device 18 in such a way that the drive device 1 is activated by the control and/or regulation device 18 depending on a sensor signal from the sensor 19 or directly by the sensor 19 in order to generate a displacement of the component 3 from the closed position 12 to the partially open position 10 or vice versa, wherein the partially open position 10 can be detected by the switch 21 or the sensor technology 39 in a direction-dependent manner and via a running carriage 30 for activating or deactivating the drive device 1.

1. An assembly comprising:
at least one, in particular exactly one and/or electrical, drive device,
a component, in particular a window or door or blind element, which can be displaced relative to a wall element for closing an opening in the wall element, and
at least one guide device, with which the component can be displaced relative to the wall element,
wherein the component can be displaced orthogonally relative to a longitudinal extension of the at least one guide device by the at least one drive device relative to the at least one guide device.

2. The assembly according to claim 1, wherein the at least one guide device is arranged in a position of use on an upper side and/or a lower side of the component and/or the component can be displaced by the at least one drive device relative to the at least one guide device parallel to the longitudinal extension of the at least one guide device.

3. The assembly according to claim 1, wherein the component is arranged parallel along the longitudinal extension of the at least one guide device, preferably between a partially open position and a fully open position and/or at least 300 mm, particularly preferably at least 600 mm, and/or the component is arranged substantially orthogonally to the longitudinal extension of the at least one guide device, preferably between a closed position and a partially open position and/or between 50 mm and 300 mm, particularly preferably between 100 mm and 150 mm.

4. The assembly according to claim 1, wherein the at least one guide device for relative displacement of the component relative to the wall element comprises a component-side guide rail and/or a wall element-side guide rail and/or the at least one guide device is integrated at least in some areas in a component stock of the wall element and/or in a frame of the component, wherein it is preferably provided that the component-side guide rail is recessed in the component and/or the wall element-side guide rail is recessed in the wall element and/or the component is arranged essentially flush with the wall element in a closed position and/or the component is arranged parallel to the wall element in a partially open position and/or in a fully open position.

5. The assembly according to claim 1, wherein the component is movable by the at least one drive device and/or manually relative to the at least one guide device preferably between a closed position and a partially open position and/or between a partially open position and a fully open position, wherein it is preferably provided that the component can be locked in the closed position, in the partially open position and/or in the fully open position, particularly preferably by a bolt that can be swiveled into the at least one drive device and/or is arranged on a roller.

6. The assembly according to claim 1, wherein the at least one drive device is coupled or can be coupled to a control and/or regulation device, preferably a building control system, wherein preferably at least one sensor, particularly preferably a CO2 sensor system, is provided for measuring a property of a building and/or the at least one drive device can be activated by the control and/or regulation device, particularly preferably in dependence on a sensor signal from the at least one sensor.

7. The assembly according to claim 1, wherein the at least one drive device can be operated manually and/or is designed in the form of a crank or at least one switch, preferably a radio switch and/or control switch, is provided, with which the at least one drive device can be activated.

8. The assembly according to claim 1, wherein the at least one drive device is arranged in the area of a corner of the component or at a central region of a side surface of the component, wherein it is preferably provided that two drive devices are arranged diagonally in the region of two corners of the component.

9. The assembly according to claim 1, wherein the at least one drive device interacts with at least one, preferably two, toggle levers comprising a hinge, wherein preferably four hinges are provided in the area of four corners of the component and/or two hinges are provided in the area of two corners of the hinge, wherein preferably four hinges are provided in the region of four corners of the component and/or two hinges are arranged on a component stock that may be present and/or two further hinges are arranged on the component, and/or movement of at least two hinges in the position of use of the arrangement is synchronized horizontally and/or vertically, and/or a toggle lever is provided to compensate for a weight load of the component and a further toggle lever is provided to guide the component.

10. The assembly according to claim 4, wherein at least one hinge is fixedly arranged on the wall element-side guide rail and at least one hinge is fixed to the component-side guide rail, so that the component-side guide rail can move relative to the wall-element-side guide rail.

11. The assembly according to claim 9, wherein exactly one drive device and two or four hinges are provided, wherein the at least one drive device is arranged on one of the two or four hinges and one of the two or two of the four hinges is/are displaceable by the at least one drive device relative to the other hinge or the other two hinges.

12. The assembly according to claim 9, wherein two horizontally oriented synchronization rods, preferably mounted so as to be displaceable, are provided in the operating position, wherein for the synchronization of at least two hinges arranged, preferably form-fittingly, on the synchronization rods, a cable comprising a figure-eight cable for rotating the synchronization rods in opposite directions, preferably between 90° and 150°, and/or the at least one hinge comprises a running carriage, wherein it is preferably provided that two running carriages are movable on the guide rail on the component side, if present, and/or two running carriages are movable on the guide rail on the wall element side, if present.

13. The assembly according to claim 9, wherein the at least one hinge is oriented at an angle to compensate for tilting or lowering of the component relative to a vertical of the operating position and/or to compensate for tilting of the component relative to a horizontal of the position of use, wherein it is preferably provided that the cable pull comprises a conical drum for shortening a cable length and/or a position-adjustable deflection roller.

14. The assembly according to claim 9, wherein a bending movement of a toggle lever of the at least one hinge from a partially open position in the direction of a fully open position can be locked and/or a clamping lever, preferably coupled to a brake, is provided, with which the at least one hinge can be automatically locked in any position between the partially open position and the fully open position, wherein the component can be displaced along the at least one guide device by actuating the clamping lever, wherein it is preferably provided that the clamping lever comprises a handle which is at least partially arranged in a frame of the component, if present, and/or can be adjusted discretely or continuously.

15. The assembly according to claim 1, wherein at least one switch and/or at least one sensor system, preferably a metal detector, is provided, by means of which a partially open position of the component can be detected and/or via which, preferably depending on detection of the partially open position starting from a fully open position, at least one drive device can be activated and/or, preferably depending on detection of the partially open position starting from a closed position, at least one drive device can be deactivated, wherein it is preferably provided that the at least one switch and/or the at least one sensor system can be actuated by a running carriage, if present, of a guide rail on the wall element side.

16. A method for moving an assembly according to claim 1, comprising the method step that the component is displaced relative to the at least one guide device via the at least one drive device, wherein the component is displaced orthogonally to the longitudinal extension of the at least one guide device relative to the at least one guide device from a closed position into a partially open position or from a partially open position into a closed position to cover the opening of the wall element.

17. The method according to claim 16, wherein the at least one drive device is locked and/or coupled to a control and/or regulation device, wherein the at least one drive device is activated by the control and/or regulation device, preferably in response to a sensor signal from at least one sensor.

18. The method according to claim 16, wherein the component, is preferably displaced via the at least one drive device, parallel to the longitudinal extension of the at least one guide device from the partially open position into a fully open position to at least partially expose the opening orthogonally to the opening or from the fully open position into the partially open position.

19. The method according to claim 16, wherein the partially open position is detected by at least one switch and/or at least one sensor system, preferably direction-dependent and/or via at least one running carriage, wherein the at least one drive device is activated or deactivated.
